(19) United States
(12) Patent Application Publication
(10) Pub. No.: US 2024/0365987 A1
(43) Pub. Date: Nov. 7, 2024

(54) LOW-COST HEIGHT ADJUSTABLE COMFORT SEAT

(71) Applicant: Dale Day Chief, Lethbridge (CA)

(72) Inventor: Dale Day Chief, Lethbridge (CA)

(21) Appl. No.: 18/095,120

(22) Filed: Jan. 10, 2023

(51) Int. Cl. A47C 15/00

(52) U.S. Cl. CPC A47C 15/004

(57) ABSTRACT

A low-cost height adjustable comfort seat including a frame assembly, legs support assembly, and structure supports assembly. The frame assembly includes a sitting structure with a lower section with inclination angle and a horizontal section. The couch cushion is attached on top of the sitting structure that creates a comfortable seat for the user. Legs support assembly includes adjustable supports in the front and spring-loaded mechanism in the rear side of the sitting structure, thereby the user may adjust the height of the sitting structure by means of the adjustable supports and the spring-loaded mechanism absorbs the weight of the user when sitting and impulse the user when standing up. The structure supports are angles attached between the sitting structure, the legs supports and the spring supports to reinforce the sitting structure.

### BACKGROUND OF THE INVENTION

### 1. Field of the Invention

The present invention relates to an adjustable seat and, more particularly, to a low-cost height adjustable comfort seat that includes a cushion on top of a seating structure is mounted onto the couch, wherein the seating structure has adjustable front legs and spring-loaded hind legs that work in concert to help the user by springing up when standing up and absorbing the weight of the user when sitting down.

### 2. Description of the Related Art

Several designs for low-cost height adjustable elevation comfort seats have been designed in the past. None of them, however, include a seat that is placed on any spot of an existing couch adjustable mechanism to adjust the height of the seat and further includes springs to help the user to stand up and cushion you when sitting.

Applicant believes that a related reference corresponds to U.S. Pat. No. 9,078,527 issued for apparatus and methods for increasing support provided by cushioned and other occupant supporting furniture. Applicant believes that another related reference corresponds to U.S. Pat. No. 9,661,935 issued for cushion restoration method. None of these references, however, teach of a retrofittable system to raise and angle the couch cushions of an existing couch to improve the ease of sitting down and then standing up.

Other documents describing the closest subject matter provide for a number of more or less complicated features that fail to solve the problem in an efficient and economical way. None of these patents suggest the novel features of the present invention.

### III. SUMMARY OF THE INVENTION

It is one of the objects of the present invention to provide a device that improves the ease of sitting down, and then standing up specially for elderly and people with mobility issues.

It is another object of this invention to provide a device that is adjustable in height according to the user's needs.

It is still another object of the present invention to provide a device that absorbs the weight of the user when sitting and impulses the user when standing up.

It is yet another object of this invention to provide such a device that is inexpensive to implement and maintain while retaining its effectiveness.

Further objects of the invention will be brought out in the following part of the specification, wherein detailed description is for the purpose of fully disclosing the invention without placing limitations thereon.

### IV. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an operational view of an exemplary embodiment of the present invention 10.

FIG. 2 shows an isometric view of the present invention 10, wherein the legs support 42 are placed in a front side of the sitting structure 22 and the spring supports 44 are placed in a rear side thereof.

FIG. 3 illustrates a lateral view of the present invention 10, wherein the legs support assembly 40 are positioned in the highest configuration thereof.

FIG. 4 is a representation of a lateral view of the present invention 10, wherein the legs support 42 are configured in the lowest configuration thereof and the spring supports 44 are in a compressed configuration.

### V. DETAILED DESCRIPTION OF THE EMBODIMENTS OF THE INVENTION

Referring now to the drawings, where the present invention is generally referred to with numeral 10, it can be observed that it basically includes a frame assembly 20, legs support assembly 40, structure supports assembly, and various exemplary embodiments (100) thereof. It should be understood there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

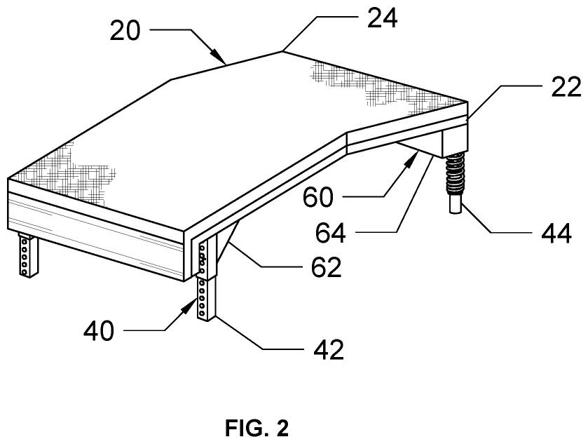

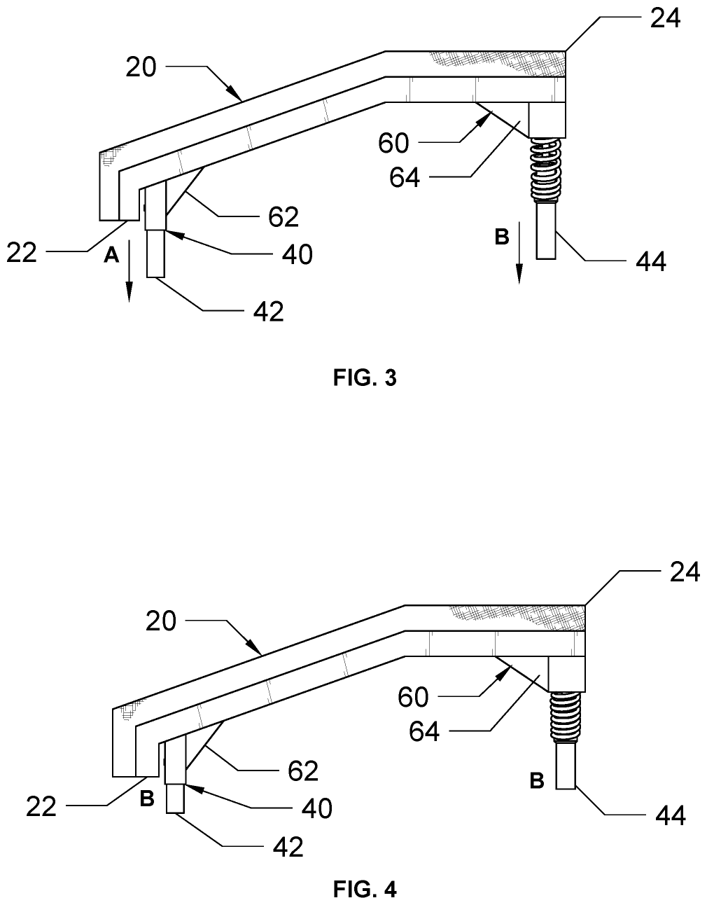

Frame assembly 20 includes a sitting structure 22 and a couch cushion 24. In an exemplary embodiment, the sitting structure 22 may be a rectangle-shaped structure, wherein a portion of the lateral sides that conforms to the sitting structure 22 may have a pitch angle. As best depicted in FIG. 2. The pitch angle provides an angle of inclination with respect to the horizontal plane, thereby providing a lower section than the rear section of the sitting structure 22. The lateral portion with the pitch angle may continue with a straight portion thereof. As shown in FIG. 3. It should be considered that the sitting structure 20 may be a square-shaped, an oval-shaped structure or any other regular or irregular shape. In a suitable embodiment, the sitting structure 22 may be made of rectangular tube, square tube, tubular or a combination thereof, wherein the material of the sitting structure 22 may be aluminum, alloy steel, carbon fiber, hard plastic or any other lightweight and strong material. In a suitable embodiment, the sitting structure 22 may have an extended section of in a front side thereof, wherein the extended section extends downwards with respect to a vertical plain. As FIG. 3 represents. In a preferred embodiment, the couch cushion 42 may extend from the extended section of the sitting structure 22 to the rear straight portion of the sitting structure 22, wherein the couch cushion 24 may be attached along the area that conforms to the sitting structure 22. As best illustrated in FIG. 2. In a preferred embodiment, the couch cushion 24 may be made of solid rubberized foam, wherein the couch cushion 24 may include a lining that contains inside thereof the couch cushion 24, thereby the couch cushion 24 in combination with the lining may create upholstered piece of furniture. It should be considered that the couch cushion 24 may be made of sponge, pad stuffed or any other suitable material.

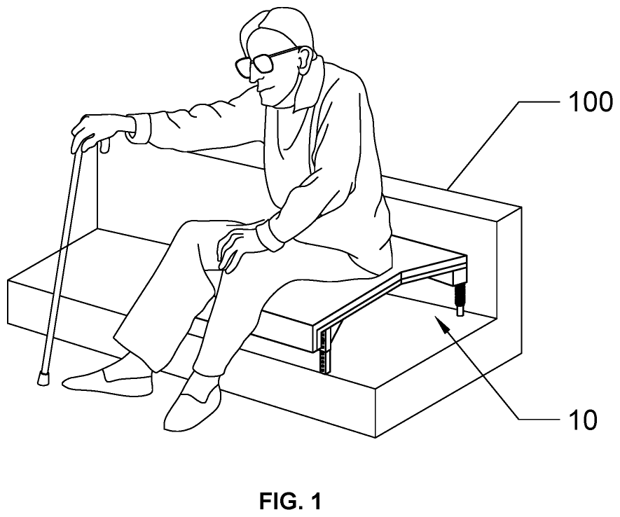

Legs support assembly 40 includes legs support 42 and spring supports 44. In an exemplary embodiment, the legs support is placed in a front portion and perpendicularly with respect to the sitting structure. As FIG. 2 illustrates. In a suitable embodiment, the legs support 42 includes a height adjustable means, such as a pin and a series of vertically displaced holes, to allow the user to set the height of the couch cushion 24 above the couch 100 as desired. As FIG. 1 represents. It should be considered that the legs support 42 may be a square tube with an inner square tube, which the inner square tube may slide along the height of the square tube and be held in place by coupling a pin through the parallel holes of both square tubes. In other embodiment, the spring support 44 may be made of a spring-loaded mechanism which allows the rear section of the couch cushion 24 to be lowered under the user's weight, and then rise up when the user adjusts the weight of his body forward to stand up from the couch cushion 24. As FIG. 3 and FIG. 4 represents. In a preferred embodiment, the spring supports is attached perpendicularly to the bottom edge with respect to the rear section of the sitting structure 22. As best depicted in FIG. 2.

Structure support assembly 60 includes front supports 62 and rear supports 64. In a suitable embodiment, the front supports 62 may angles attached between the legs support 42 and the laterals of the seating structure 22. As FIG. 3 depicts. The front supports 62 may reinforce the sitting structure 22 by transferring the loads created when the user sits on the couch cushion 24 between the sitting structure 22 and the legs support 42, thereby said front supports 62 provide resistance to bending in any direction. In a preferred embodiment, the front supports 62 may be made of the same material as the sitting structure 22 and/or the legs supports 42. In other embodiment, rear supports 64 may angles attached between the spring supports 44 and the laterals of the seating structure 22. As FIG. 3 depicts. The rear supports 64 may reinforce the sitting structure 22 by transferring the loads created when the user sits on the couch cushion 24 between the sitting structure 22 and the spring supports 44, thereby said rear supports 64 provide resistance to bending in any direction. In a preferred embodiment, the rear supports 64 may be made of the same material as the sitting structure 22 and/or the spring supports 42. It should be considered that the springs support 44 may include and adjustable mechanism to be leveled in accordance with the legs support 42, thereby the legs support 42 and the springs support 44 may work in concert to level the couch cushion with respect to a horizontal plane.

Referring to the figures and more particularly to FIG. 1, wherein the present invention 10 may provide an adjustable in height means for elderly, users with mobility difficulties, thereby the frame assembly 20 is capable of adjusting in height by means of the legs support 42, providing a predetermined height that the user considers appropriate for sitting. The spring supports 42 may provide a force absorption when compressed and may provide an impulse when the user adjusts the weight of his body forward to stand up.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A low-cost height adjustable comfort seat, comprising:
a frame assembly including a sitting structure and a couch cushion, wherein said sitting structure may be a rectangular-shaped structure that is adapted to support a weight of a user, wherein said couch cushion is a rubberized foam coupled on top of said sitting structure that is adapted to receive said user when sitting;
a legs support assembly having legs support and spring supports, wherein said legs support are attached at a bottom edge of said sitting structure, said legs supports is perpendicularly with respect to said sitting structure, where said spring supports are symmetrically attached at the opposite edge with respect to said legs support, said legs supports are adjustable in height and said spring supports is a spring-loaded mechanism; and
a structure support assembly including front supports and rear supports, wherein said front supports are attached between said sitting structure and said legs support, said rear supports are attached between said sitting structure and said spring supports.

2. The low-cost height adjustable comfort seat of claim 1, wherein said rectangular-shaped structure includes a pitch angle by means of the lateral thereof.

3. The low-cost height adjustable comfort seat of claim 2, wherein said pitch angle creates a lower section than the rear section of said sitting structure.

4. The low-cost height adjustable comfort seat of claim 3, wherein said lower section has an angle of inclination, while the rear section has a vertical angle with respect to the horizontal plane.

5. The low-cost height adjustable comfort seat of claim 1, wherein said sitting structure has an extended section downwards with respect to a vertical plane of a front side of said sitting structure.

6. The low-cost height adjustable comfort seat of claim 1, wherein said couch cushion is attached along an area formed by said sitting structure.

7. The low-cost height adjustable comfort seat of claim 1, wherein said couch cushion has a lining that covers said couch cushion creating an upholstered piece of furniture.

8. The low-cost height adjustable comfort seat of claim 1, wherein said legs support is a square tube with an inner square tube, wherein said legs support includes a series of vertically displaced holes, wherein said inner square tube slides along an internal portion of said square tube and is held in place by coupling a pin through the holes of said series of vertically displaced holed parallel placed.

9. The low-cost height adjustable comfort seat of claim 1, wherein said front support and said rear support are angles that divide a load caused by said weight of said user when sitting, said angles reinforce said sitting structure.

10. An low-cost height adjustable comfort seat, comprising:
a frame assembly including a sitting structure and a couch cushion, wherein said sitting structure may be a rectangular-shaped structure that is adapted to support a weight of a user, said rectangular-shaped structure includes a pitch angle by means of the lateral thereof, said pitch angle creates a lower section than the rear section of said sitting structure, wherein said lower section has an angle of inclination, while the rear section has a vertical angle with respect to the horizontal plane, wherein said couch cushion is a rubberized foam coupled on top of said sitting structure that is adapted to receive said user when sitting;
a legs support assembly having legs support and spring supports, wherein said legs support are attached at a bottom edge of said sitting structure, said legs supports is perpendicularly with respect to said sitting structure, where said spring supports are symmetrically attached at the opposite edge with respect to said legs support, said legs supports are adjustable in height and said spring supports is a spring-loaded mechanism, wherein said legs support is a square tube with an inner square tube, wherein said legs support includes a series of vertically displaced holes; and
a structure support assembly including front supports and rear supports, wherein said front supports are attached between said sitting structure and said legs support, said rear supports are attached between said sitting structure and said spring supports, said front support and said rear support are angles that divide a load caused by said weight of said user when sitting.

11. A low-cost height adjustable comfort seat, consisting of:
a frame assembly including a sitting structure and a couch cushion, wherein said sitting structure may be a rectangular-shaped structure that is adapted to support a weight of a user, said rectangular-shaped structure includes a pitch angle by means of the lateral thereof, said pitch angle creates a lower section than the rear section of said sitting structure, wherein said lower section has an angle of inclination, while the rear section has a vertical angle with respect to the horizontal plane, wherein said couch cushion is a rubberized foam coupled on top of said sitting structure that is adapted to receive said user when sitting, said couch cushion is attached along an area that conforms an area of said sitting structure, wherein said couch cushion have a lining that covers said couch cushion creating an upholstered piece of furniture;
a legs support assembly having legs support and spring supports, wherein said legs support are attached at a bottom edge of said sitting structure, said legs supports is perpendicularly with respect to said sitting structure, where said spring supports are symmetrically attached at the opposite edge with respect to said legs support, said legs supports are adjustable in height and said spring supports is a spring-loaded mechanism, wherein said legs support is a square tube with an inner square tube, wherein said legs support includes a series of vertically displaced holes, wherein said inner square tube slides along an internal portion of said square tube and is held in place by coupling a pin through the holes of said series of vertically displaced holed parallel placed; and
a structure support assembly including front supports and rear supports, wherein said front supports are attached between said sitting structure and said legs support, said rear supports are attached between said sitting structure and said spring supports said front support and said rear support are angles that divide a load caused by said weight of said user when sit, said angles reinforce said sitting structure.
